(19) United States
(12) Patent Application Publication
(10) Pub. No.: US 2023/0227303 A1
(43) Pub. Date: Jul. 20, 2023

(54) BEVERAGE DISPENSER

(71) Applicant: Celli S.p.A., San Giovanni in Marignano (IT)

(72) Inventors: Marco PIOVANO, San Giovanni in Marignano (IT); Andrea TONONI, San Giovanni in Marignano (IT); Daniele CECCARINI, San Giovanni in Marignano (IT); Giovanni RAZZANI, San Giovanni in Marignano (IT)

(73) Assignee: Celli S.p.A., San Giovanni in Marignano (IT)

(21) Appl. No.: 18/098,134

(22) Filed: Jan. 18, 2023

(30) Foreign Application Priority Data
Jan. 18, 2022 (IT) 102022000000680

(51) Int. Cl. B67D 1/14; B67D 1/00; B67D 1/08

(52) U.S. Cl. CPC B67D 1/1477; B67D 1/0085; B67D 1/0888; B67D 2001/1483; B67D 2001/0089

(57) ABSTRACT

The present invention relates to a dispenser (1) of beverages such as beer, carbonated beverages, non-carbonated beverages and the like, comprising: a regulating unit (2) for regulating the flow rate of at least one beverage, wherein said regulating unit (2) comprises at least one regulating group (20, 21, 22, 23) having at least one lever (200, 210, 220, 230) operable by a user between a rest position, in which said at least one beverage is not dispensed, and at least one operating position, in which said at least one beverage is dispensed with a predetermined flow rate, and a dispensing unit (3) operatively connected to said regulating unit (2), for dispensing said at least one beverage, wherein said dispensing unit (3) comprises at least one first valve (30A, 31A, 32A, 33A) movable between a closed position and an open position to allow the dispensing of said at least one beverage with said predetermined flow rate; and at least one control logic unit (U0, U1, U2, U3) connected to said at least one regulating group (20, 21, 22, 23) and said at least one first valve (30A, 31A, 32A, 33A) respectively, wherein each regulating group (20, 21, 22, 23) comprises a respective processing unit (E0, E1, E2, E3) configured to send an electrical signal to said at least one logic control unit (U0, U1, U2, U3) respectively, when said at least one lever (200, 210, 220, 230) is in said operating position, and wherein said at least one logic control unit (U0, U1, U2, U3) is configured to: receive said electrical signal from said processing unit (E0, E1, E2, E3), and activate the opening of said at least one first valve (30A, 31A, 32A, 33A) for dispensing said at least one beverage.

### RELATED APPLICATION

This application claims the benefit of priority of Italy Patent Application No. 102022000000680 filed on Jan. 18, 2022, the contents of which are incorporated by reference as if fully set forth herein in their entirety.

### FIELD AND BACKGROUND OF THE INVENTION

The present invention relates to a beverage dispenser.

More specifically, the invention relates to a beverage dispenser of the above type, designed and manufactured in particular to allow a user to control and adjust the dispensing of one or more beverages such as, for example, water, beer, soft drinks carbonated, non-carbonated beverages, and the like, in an optimal way.

In the following, the description will be directed to a beverage dispenser or distributor suitable for the restaurant sector (so-called “HORECA” sector), but it is quite clear that the same should not be considered limited to this specific use.

As is well known, beverage dispensers or distributors are currently widespread in venues such as, for example, bars, ice-cream parlors, fast-food or self-service restaurants, and the like. These dispensers can be operated manually by the users, to autonomously dispense one or more beverages.

In particular, these beverage dispensers generally comprise one or more activation/interruption buttons for activating or interrupting the dispensing of the respective beverages possibly selected by the user.

More in detail, when a beverage needs to be dispensed, the user can hold down the activation/interruption button associated with a respective beverage to activate its dispensing, filling the container such as, for example, a glass, positioned at a respective dispensing nozzle, until a desired filling level is reached. In this case, the dispensing is interrupted by releasing the activation/interruption button.

Alternatively, some beverage dispensers are designed to automatically fill the glass with the respective selected beverage, and according to a predefined quantity (so-called size), against a single press of the activation/stop button by the user. In these cases, normally, during the automatic dispensing of the beverage, the user can, however, press the same activation/interruption button a second time to interrupt dispensing of the beverage.

Furthermore, known solutions also comprise levers arranged below respective dispensing nozzles, for each beverage.

In particular, each lever can be operated by the user by exerting pressure, by means of the respective glass, on the same lever, to start dispensing the desired beverage. When this pressure is no longer present, dispensing of the beverage stops.

However, a drawback of these known solutions consists in the fact that they do not allow the user to precisely and effectively control the dispensing of the specific beverage. In fact, as mentioned, these solutions only provide for the possibility of activating or interrupting the dispensing of one or more beverages by using one or more buttons or levers that cannot be operated directly by the user, i.e., designed to be operated via the glass held by the user.

In addition, the use of buttons does not give the user a pleasant sensation during the dispensing act, such as that obtained using levers arranged in correspondence with the respective nozzles, and activated by pushing the glass, making it unpleasant for the user the delivery act itself, as well as impractical and controllable, as already mentioned above.

In light of the above, it is, therefore, an object of the present invention providing a beverage dispenser, which can overcome the limitations of the solutions according to the prior art.

Another object of the invention is to provide a beverage dispenser that is highly reliable, relatively simple to manufacture, and at competitive costs when compared to the prior art.

### SUMMARY OF THE INVENTION

It is, therefore, specific object of the present invention a dispenser of beverages such as beer, carbonated beverages, non-carbonated beverages and the like, comprising: a regulating unit for regulating the flow rate of at least one beverage, wherein said regulating unit comprises at least one regulating group having at least one lever operable by a user between a rest position, in which said at least one beverage is not dispensed, and at least one operating position, in which said at least one beverage is dispensed with a predetermined flow rate, and a dispensing unit operatively connected to said regulating unit, for dispensing said at least one beverage, wherein said dispensing unit comprises at least one first valve movable between a closed position and an open position to allow the dispensing of said at least one beverage with said predetermined flow rate; and at least one control logic unit connected to said at least one regulating group and said at least one first valve respectively, wherein each regulating group comprises a respective processing unit configured to send an electrical signal to said at least one logic control unit respectively, when said at least one lever is in said operating position, and wherein said at least one logic control unit is configured to: receive said electrical signal from said processing unit, and activate the opening of said at least one first valve for dispensing said at least one beverage.

Advantageously according to the invention, said at least one lever may be operable by said user between said rest position and a plurality of operating positions, wherein each operating position of said plurality of operating positions is associated with a respective predefined flow rate and a type of beverage which is also different with respect to each operating position of said at least one lever, so that, when said at least one lever is in one of said operating positions, the respective type of beverage with said predefined flow rate is dispensed.

Conveniently according to the invention, said at least one lever may be operable by said user between said rest position and a plurality of operating positions, wherein each operating position of said plurality of operating positions is associated with a respective flow rate of at least one type of beverage which is also different with respect to each operating position of said at least one lever, so that, when said at least one lever is in one of said operating positions, the respective type of beverage with said respective flow rate is dispensed.

Still according to the invention, said dispensing unit may comprise at least one second valve, connected to said at least one logic control unit and movable likewise between a closed position and an open position to allow the dispensing of at least one further beverage, such that, when said at least one lever is operated by said user from said rest position to an operating position of said plurality of operating positions, said at least one second valve switches from said closed position to said open position, allowing the dispensing of said at least one further beverage.

Always according to the invention, each processing unit may be configured to send a plurality of electrical signals to said at least one logic control unit respectively, when said at least one lever is in an operating position of said plurality of operating positions, such that said at least one logic control unit is able to activate the opening of each valve for dispensing said at least one beverage with said predefined flow rate and/or said respective flow rate.

Advantageously according to the invention, each processing unit may comprise a transducer configured to convert each operating position of said at least one lever into a respective electrical signal.

Still according to the invention, said transducer may be selected from: a selecting member, a potentiometer, a magnetic sensor, an ultrasonic position sensor and an inductive sensor.

Conveniently according to the invention, said at least one regulating group may comprise a first selecting member coupled to said lever, and a first switching device operable by said first selecting member, wherein when said lever passes from said rest position to an operating position related to one of said operating positions, said first selecting member interferes with said first switching device so as to switch its state.

Always according to the invention, said at least one control unit may comprise a second selecting member also coupled to said lever, wherein said second selecting member is rotated by a predetermined angle with respect to said respective first selecting member, and a second switching device operable by a respective second selecting member of a respective adjustment group, so that when one of said levers rotates from said rest position to a further operating position related to one of said operating positions, said second selecting member interferes with said second switching device so as to switch its state.

Advantageously according to the invention, each switching device may be operable by a respective selecting member.

Conveniently according to the invention, said lever may be capable of rotating according to a first direction of rotation or a second direction of rotation, opposite to said first direction of rotation.

Always according to the invention, each lever may comprise at least one haptic device for providing haptic feedback, such as vibrations and the like, to a user when operating the respective lever for dispensing at least one of said beverages.

Still according to the invention, said at least one haptic device may be capable of providing different haptic feedback depending on said predefined flow rate and/or said type of beverage.

### BRIEF DESCRIPTION OF THE SEVERAL VIEWS OF THE DRAWINGS

The present invention will be now described, for illustrative but not limitative purposes, according to its preferred embodiments, with particular reference to the figures of the enclosed drawings, wherein:

FIG. 1 shows, in perspective view, a beverage dispenser, according to the present invention;

FIG. 2A shows, in perspective view, a first unit for regulating the flow of at least one drink, in a first operating position;

FIG. 2B shows, in perspective view, a second assembly for regulating the flow of said at least one beverage, in a rest position;

FIG. 2C shows, in perspective view, a third assembly for regulating the flow of said at least one beverage, in said rest position;

FIG. 2D shows, in perspective view, a unit for regulating the flow of said at least one beverage, in a second operating position;

FIG. 3A shows, in top view, the first unit for regulating the flow of said at least one beverage of FIG. 2A;

FIG. 3B is a top view of the second unit for regulating the flow of said at least one beverage of FIG. 2B;

FIG. 3C shows, in a top view, the third unit for regulating the flow of said at least one beverage of FIG. 2C;

FIG. 3D shows, in top view, the fourth unit for regulating the flow of said at least one beverage of FIG. 2D;

FIG. 4A shows, in front view, the first unit for regulating the flow of said at least one beverage of FIG. 2A;

FIG. 4B is a front view of the second unit for regulating the flow of said at least one beverage of FIG. 2B;

FIG. 4C shows, in front view, the third unit for regulating the flow of said at least one beverage of FIG. 2C;

FIG. 4D shows, in front view, the fourth unit for regulating the flow of said at least one beverage of FIG. 2D;

FIG. 5 shows, in side view and in detail, the assemblies for regulating the flow of said at least one drink, installed in the drink dispenser, according to the present invention; and

FIG. 6 shows, in a schematic view, a connection between a regulating unit and a dispensing unit, according to the present invention.

In the various figures, similar parts will be indicated with the same reference numbers.

### DESCRIPTION OF SPECIFIC EMBODIMENTS OF THE INVENTION

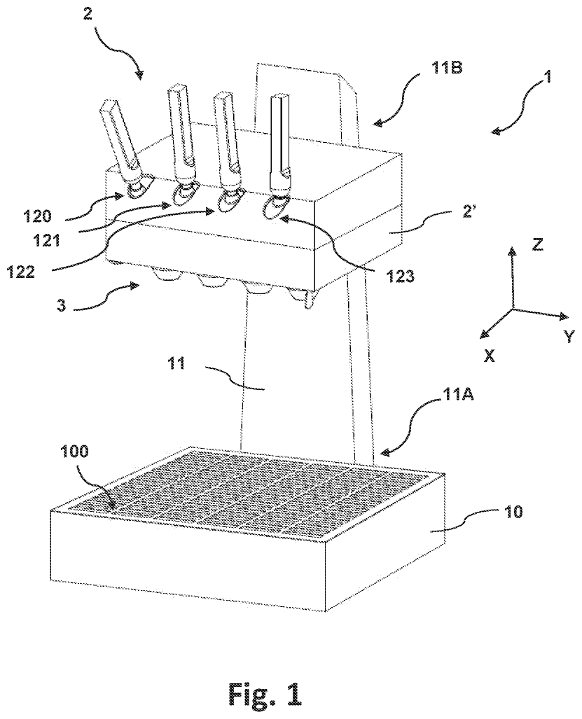

With reference to FIG. 1, the dispenser of beverages such as water, beer, carbonated drinks, and the like, indicated as a whole with the reference number 1, comprises a drip tray base 10, a support column 11 fixed to said base 10, a regulating unit 2 for regulating the dispensing of at least one of said beverages and a dispensing unit 3, operatively connected to said regulating unit 2, for dispensing at least one of said beverages.

It should be noted that, for the purposes of the present invention, the support column 11 could not be fixed to said base 10, but simply arranged in proximity to said base 10. In this case, said support column 10 can be fixed directly to the support 10 by means of fastening means such as, for example, clamps.

The drip tray base 10, having a substantially rectangular shape, has a surface 100, on which the receptacles or containers (not shown in the figures) are positioned, such as, for example, glasses and the like, to be filled with the respective beverages dispensed by said dispensing unit 3.

In the embodiment described, said base 10 develops on a plane XY of a Cartesian reference system XYZ. However, in other embodiments, the base 10 can have a different shape, without thereby departing from the scope of protection of the present invention.

The support column 11 has one end 11A fixed to said base 10, and another end 11B fixed to said regulating unit 2.

In particular, as can be seen from FIG. 1, the support column 11 develops in height, substantially in the direction of a Z-axis, perpendicular to the XY-plane of the Cartesian reference system XYZ.

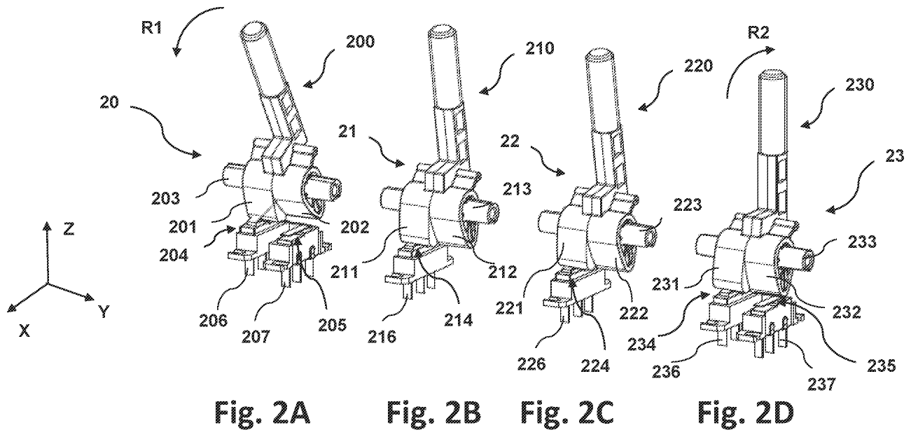

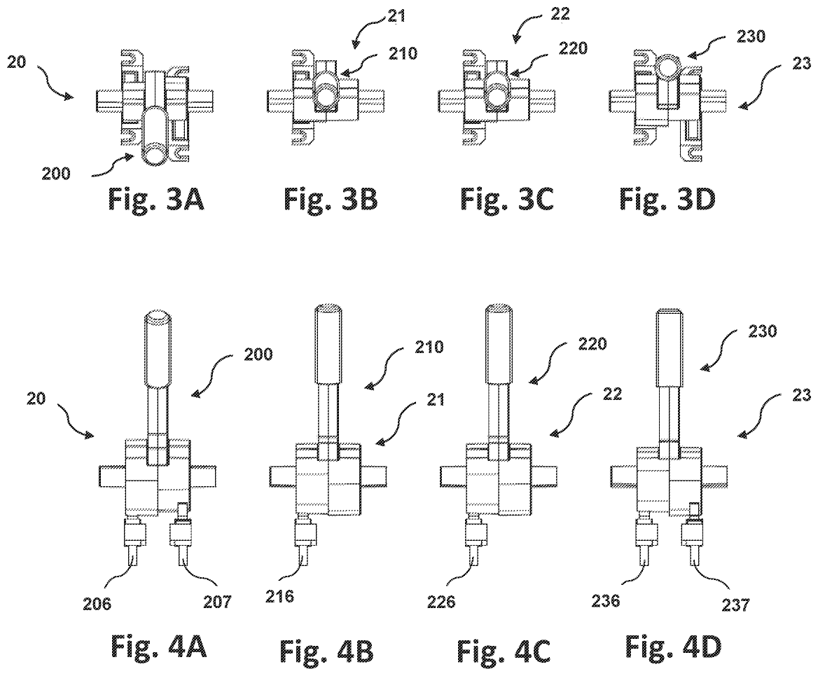

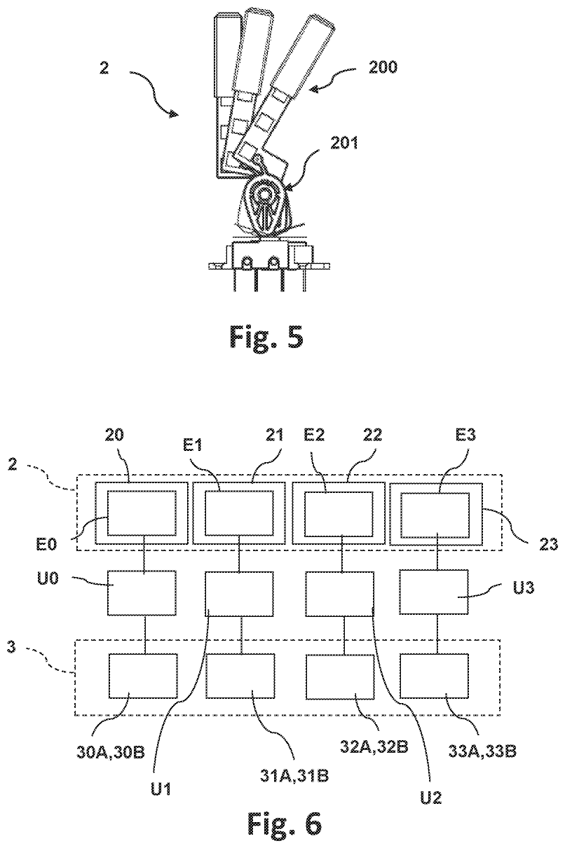

With particular reference to FIGS. 2A-2D, 3A-3D, 4A-4D, and 5, said regulating unit 2 comprises a containment structure 2′ and a plurality of regulating groups 20, 21, 22, and 23, arranged inside said containing structure 12, in which each regulating group 20, 21, 22, and 23 is configured to regulate the flow rate of each beverage. The term “regulating” means both a continuous regulation of the flow, and a discrete regulation of the flow, and a simple on-off regulation, that is of generation and interruption of the flow.

In particular, in the present embodiment, said regulating unit 2 comprises a first regulating group 20 arranged close to a first side of said containment structure 2′, a second regulating group 21 arranged alongside said first regulating group 20, a third regulating group 22, arranged alongside said second regulating group 21, and a fourth regulating group 23, arranged close to a second side of said containment structure 2′, in which said second side is opposite said first side.

However, in other embodiments, the number and arrangement of said regulating groups 20, 21, 22, and 23 can be different from what is described.

Each regulating group 20, 21, 22, and 23 comprises a lever respectively indicated with the reference numbers 200, 210, 220, and 230, which can be operated manually by a user, a first selecting member 201, 211, 221, and 231 coupled to said lever 200, 210, 220, and 230, a second selecting member 202, 212, 222, and 232, also coupled to said lever 200, 210, 220, and 230, and at least one first switching device 204, 214, 224, and 234 capable of switching from a closed or non-operating position, to an open or operating position and vice versa.

As can be seen from FIG. 1, each lever 200, 210, 220, and 230 protrudes from a respective opening 120, 121, 122, and 123 formed in said containment structure 2′, so as to be easily gripped and operated by the user. This feature makes the dispensing act pleasant for the user.

In particular, each lever 200, 210, 220, and 230 can pass from a rest position, in which the dispensing of the beverage is not active, to at least one operating position, in which said at least one beverage is dispensed with a respective flow rate and pressure.

More specifically, in the present embodiment, each lever 200, 210, 220, and 230 can be operated by the user effectively simulating the operation of a tap for beer and the like, capable of dispensing beer and the like by controlling, by actuation of the respective lever 200, 210, 220 and 230, the flow of the liquid and of the carbon dioxide. In dispensers, the regulation of the dispensing tap is mechanical, and the activation of the lever allows the feeling of the fluid being dispensed. The dispenser 1 according to the present invention actually simulates this feeling.

In other embodiments of the present invention, each operating position of said lever 200, 210, 220, and 230 can correspond to respective functions.

In an embodiment of the present invention, when said lever 200, 210, 220, and 230 is in an operative position, the dispensing of the beverage can be timed by, for example, a relay configured to open or close the electrical contacts, after a pre-set time interval has elapsed.

In a further embodiment of the present invention, when said lever 200, 210, 220, and 230 is in an operative position, the flow rate of the dispensed beverage can be predetermined on the basis of the size, or dimension, of the container to be filled.

In another embodiment of the present invention, a respective type of dispensed beverage can be associated with each operating position of said lever 200, 210, 220, and 230.

Again, in one embodiment, each lever 200, 210, 220, 230 can be operated between said rest position and a plurality of operating positions, in which each operating position of said plurality of operating positions is associated with a respective pre-definable range and a type of beverage, even different with respect to each operating position of the same lever 200, 210, 220, 230.

Therefore, when said lever 200, 210, 220, 230 is in one of said operating positions, the respective type of beverage is dispensed with this predefinable range. By way of example, for each operating position of said lever 200, 210, 220, 230 the same type of beverage can be dispensed with a different flow rate.

In another embodiment, each lever 200, 210, 220, 230 can be operated between said rest position and a plurality of operating positions, in which each operating position of said plurality of operating positions is associated with a respective range of at least a type of beverage even different with respect to each operating position of the same lever 200, 210, 220, 230.

Therefore, when said at least one lever 200, 210, 220, 230 is in one of said operating positions, the respective type of beverage is dispensed with said respective flow rate. By way of example, for each operating position of said lever 200, 210, 220, 230, a different type of beverage can be dispensed with the same flow rate.

In a further embodiment of the present invention, each lever 200, 210, 220, and 230 may include one or more haptic devices (not shown in the figures) for providing haptic feedback such as, for example, vibration and the like, to the user when the latter uses the respective lever 200, 210, 220, and 230 to dispense a beverage. In this way, in fact, the user can perceive, through the touch, the level of pressure and flow rate associated with the specific dispensed beverage.

That is, each lever 200, 210, 220, and 230 may include at least one haptic device for providing haptic feedback, such as vibrations and the like, to a user when actuating the respective lever 200, 210, 220, 230 for delivery of at least one of these beverages.

By way of example, said haptic device can comprise a motor, an actuator or a piezoelectric sensor. However, in other embodiments, the number and type of said haptic devices can be different without thereby departing from the scope of protection of the present invention.

In particular, each haptic device is capable of providing a different haptic feedback as a function of said predefinable flow rate and/or of said type of beverage to be dispensed.

With reference to FIGS. 2A-2D, each regulating group 20, 21, 22, and 23 comprises a respective bar 203, 213, 223, and 233, having a cylindrical section, which develops along the direction of a Y axis, perpendicular to said Z axis of the Cartesian reference system XYZ. In particular, the ends of each bar 203, 213, 223, and 233 can be fixed to the sides of respective structures (not shown in the figures) to guarantee the stability of the regulating groups 20, 21, 22 and 23.

In the embodiment described, each selector member 201, 202, 211, 212, 221, 222, 231, and 232 is a cam, such that, when the lever 200, 210, 220, and 230 is rotated, the cam 201, 202, 211, 212, 221, 222, 231, and 232 respectively associated interfere with a respective switching device 204, 214, 224, or 234 and allow the beverage to be dispensed.

However, in other embodiments, the type of said selecting member 201, 202, 211, 212, 221, 222, and 232 can be different from what is described.

Furthermore, as will be better explained hereinafter, each lever 200, 210, 220, and 230 is capable of rotating around the respective bar 203, 213, 223, and 233 according to a first direction of rotation R1 or according to a second rotation direction R2, opposite to said first rotation direction R1.

In addition, each first cam 201, 211, 221, and 231 has one end respectively fixed to said lever 200, 210, 220, and 230 and another end free to move and to contact said first switching device 204, 214, 224, and 234 such as, for example, a switch and the like, thereby switching its state.

Similarly, each second cam 202, 212, 222, and 232 has one end respectively fixed to said lever 200, 210, 220, and 230 and another end free to move and to contact a second switching device 205, 235 as, for example, a switch and the like, so as to switch its state.

In more detail, with reference to the FIGS. 2A-2D, each first cam 201, 211, 221, and 231 is rotated with respect to the respective second cam 202, 212, 222, and 232 (i.e., it is eccentric with respect to it) by a predetermined angle, so as to interfere at different times respectively with said first switching device 204, 214, 224, and 234 and with said second switching device 205, 235, activating the delivery of a specific beverage, as better described hereinafter.

In the present embodiment, said first regulating group 20 and said fourth regulating group 23 respectively comprise two switching devices 204, 205, 234, and 235, while said second regulating group 21 and said third regulating group 22 respectively comprise a switching device 214 and 224.

However, in other embodiments, the number and type of said switching devices 204, 205, 214, 224, 234, and 235, may be different from what is described.

In other embodiments of the present invention, each regulating group 20, 21, 22, and 23 can comprise, in addition or in place of said switching devices 204, 205, 214, 224, 234, and 235, one or more proximity sensors (not shown in the figures) such as, for example, magnetic sensors and the like, to detect the position of said lever 200, 210, 220, and 230, one or more encoders (not shown in the figures), or one or more resistors (not shown in the figures).

Each regulation group 20, 21, 22, and 23 comprises a respective processing unit E0, E1, E2, E3 configured to respectively send an electrical signal to at least one logic control unit U0, U1, U2, U3, when at least one lever 200, 210, 220, 230 is in the operating position.

Furthermore, each regulating group 20, 21, 22 and 23 comprises a plurality of electrical connection means 206, 207, 216, 226, 236, and 237 such as, for example, pins and the like, for connecting each switching device 204, 205, 214, 224, 234, 235 to a respective control logic unit U0, U1, U2, U3.

Each logic control unit such as, for example, an electronic card, a computer or a plurality of computers, is configured to receive electrical signals from each processing unit E0, E1, E2, E3 of the respective regulation group 20, 21, 22, and 23 when said switching devices 204, 205, 214, 224, 234, 235 are in said operating position, and to consequently activate said dispensing unit 3 for dispensing beverages.

As said and as can be seen from FIG. 6, the dispensing unit 3 is operatively connected to said regulating unit 2, and comprises a plurality of valves 30A, 30B, 31A, 31B, 32A, 32B, 33A, 33B movable between a closed position and an open position to allow the dispensing of at least one beverage with a predetermined flow rate associated with respective dispensing nozzles for dispensing the beverages. In one embodiment of the present invention, said valves 30A, 30B, 31A, 31B, 32A, 32B, 33A, 33B can be solenoid valves of the on-off type, i.e., bistable or monostable. In this case, the valves 30A, 30B, 31A, 31B, 32A, 32B, 33A, 33B only allow the activation and interruption of the flow. In other embodiments, the valves 30A, 30B, 31A, 31B, 32A, 32B, 33A, 33B can be proportional solenoid valves, that is, they can regulate the flow rate in a continuous or discrete way of the flow passing through them.

Each control logic unit U0, U1, U2, U3 is capable of activating the opening of one or more valves 30A, 30B, 31A, 31B, 32A, 32B, 33A, 33B for dispensing the specific beverage through the respective dispensing nozzle.

In one embodiment, the dispensing unit 3 comprises a respective first valve 30A, 31A, 32A, 33A for each regulating group 20, 21, 22, 23.

Each first valve 30A, 31A, 32A, 33A is movable between a closed position and an open position to allow the dispensing of at least one beverage with a predetermined flow rate.

In another embodiment, the dispensing unit 3 also comprises a respective second valve 30B, 31B, 32B, 33B for each regulating group 20, 21, 22, 23.

Each second valve 30B, 31B, 32B, 33B is also movable between a closed position and an open position to allow the dispensing of at least one further beverage with a predetermined flow rate.

The operation of the beverage dispenser 1 described above is as follows.

Initially, each lever 200, 210, 220, and 230 of the respective regulating group 20, 21, 22, and 23 is in said rest position, as can be seen from FIGS. 2B and 2C. Furthermore, each first cam 201, 211, 221, and 231 and each second cam 202, 212, 222, and 232 do not interfere respectively with said first switching device 204, 214, 224, and 234 and with said second switching device 205, 235, which are in said non-operating position.

Therefore, in this state or configuration said beverage dispenser 1 does not dispense any beverage by means of said regulating group 20, 21, 22, and 23.

Subsequently, in the event that the user requires a beverage that can be dispensed by the regulating group 20, he/she actuates the lever 200, rotating it according to said first direction of rotation R1, from said rest position to said operating position.

As said, in a further embodiment of the present invention, a rotation of said lever 200 according to said first rotation direction R1 from said rest position to an operating position of a plurality of operating positions can correspond to the dispensing of a type of beverage with a pre-definable flow rate.

The rotation of said lever 200 according to said first rotation direction R1 around the respective bar 203 allows said first cam 201 to contact said first switching device 204, so as to switch its state from non-operating to operating.

On the other hand, following the same rotation of the lever 200, as can be seen from FIG. 2A, the second cam 202 does not interfere with said second switching device 205, which, therefore, remains in the inoperative state.

In fact, as mentioned, each first cam 201, 211, 221, and 231 is rotated, i.e., the respective lobes are out of phase, with respect to the lobes of the respective second cam 202, 212, 222, and 232 by a predetermined angle, so as to interfere in different moments respectively with said first switching device 204, 214, 224, and 234 and with said second switching device 205, 235, activating the delivery of a specific beverage.

Therefore, when said first switching device 204 is in the operative state, an electrical signal is transmitted from the respective processing unit E0 of said regulation group 20 to said logic control unit U0, by means of respective electrical connection means 206.

Consequently, said control logic unit U0 starts the dispensing of the beverage by sending a control signal for opening a respective valve 30A, 30B of the dispensing unit 3 associated with a respective first beverage. The opening of the valve 30A, 30B can be complete, or it can be adjusted according to the control signal sent by the logic control unit U0.

If, on the other hand, the user needs another beverage that can be dispensed from the same regulating group 20, he/she holds the lever 200, rotating it in the second direction of rotation R2, opposite to said first rotation direction R1, from said rest position to said operating position.

Also in this case, as anticipated, in a further embodiment of the present invention, a rotation of said lever 200 according to said second rotation direction R2 from said rest position to an operating position of a plurality of operating positions can correspond to the dispensing of a further type of beverage with a pre-definable flow rate.

As can also be seen from FIG. 2D referring to the fourth regulating group 23, the rotation of said lever 200 around the respective bar 203 allows said second cam 202 to contact said second switching device 205, so as to switch its status from non-operating to operating.

On the other hand, following the same rotation of the lever 200, the first cam 201 does not contact said first switching device 204, which therefore remains in the non-operating state.

Therefore, in analogy to the previous case, when said second switching device 205 is in the operating state, an electrical signal is transmitted from the respective processing unit E0 of said regulation group 20 to said logic control unit U0 by means of respective electrical connection means 207, said logic control unit U0 starts dispensing the beverage by sending a control signal for opening a respective valve 30A, 30B of the dispensing unit 3 associated with a respective second beverage, different from the first beverage. Also in this case, similarly to the previous one, the opening of the valves 30A, 30B can be completed, or it can be adjusted according to the control signal sent by the logic control unit U0.

An advantage of the beverage dispenser according to the present invention is that it allows the user to easily access the levers of the regulating groups, positioned in the upper portion of the beverage dispenser, so as to manually adjust and manage the delivery of one or more beverages.

The present invention has been described for illustrative but not limitative purposes, according to its preferred embodiments, but it is to be understood that modifications and/or changes can be introduced by those skilled in the art without departing from the relevant scope as defined in the enclosed claims.

What is claimed is:

1. Dispenser of beverages such as beer, carbonated beverages, non-carbonated beverages and the like, comprising:
a regulating unit for regulating the flow rate of at least one beverage, wherein said regulating unit comprises
at least one regulating group having at least one lever operable by a user between a rest position, in which said at least one beverage is not dispensed, and at least one operating position, in which said at least one beverage is dispensed with a predetermined flow rate, and
a dispensing unit operatively connected to said regulating unit, for dispensing said at least one beverage, wherein said dispensing unit comprises at least one first valve movable between a closed position and an open position to allow the dispensing of said at least one beverage with said predetermined flow rate; and
at least one control logic unit connected to said at least one regulating group and said at least one first valve respectively,
wherein each regulating group comprises a respective processing unit configured to send an electrical signal to said at least one logic control unit respectively, when said at least one lever is in said operating position, and
wherein said at least one logic control unit is configured to:
receive said electrical signal from said processing unit, and
activate the opening of said at least one first valve for dispensing said at least one beverage.

2. Dispenser of beverages according claim 1, wherein said at least one lever is operable by said user between said rest position and a plurality of operating positions,
wherein each operating position of said plurality of operating positions is associated with a respective predefined flow rate and a type of beverage which is also different with respect to each operating position of said at least one lever,
so that, when said at least one lever is in one of said operating positions, the respective type of beverage with said predefined flow rate is dispensed.

3. Dispenser of beverages according to claim 1, wherein said at least one lever is operable by said user between said rest position and a plurality of operating positions,
wherein each operating position of said plurality of operating positions is associated with a respective flow rate of at least one type of beverage which is also different with respect to each operating position of said at least one lever,
so that, when said at least one lever is in one of said operating positions, the respective type of beverage with said respective flow rate is dispensed.

4. Dispenser of beverages according to claim 1, wherein said dispensing unit comprises at least one second valve, connected to said at least one logic control unit and movable likewise between a closed position and an open position to allow the dispensing of at least one further beverage, such that, when said at least one lever is operated by said user from said rest position to an operating position of said plurality of operating positions, said at least one second valve switches from said closed position to said open position, allowing the dispensing of said at least one further beverage.

5. Dispenser of beverages according to claim 1, wherein each processing unit is configured to send a plurality of electrical signals to said at least one logic control unit respectively, when said at least one lever is in an operating position of said plurality of operating positions, such that said at least one logic control unit is able to activate the opening of each valve for dispensing said at least one beverage with said predefined flow rate and/or said respective flow rate.

6. Dispenser of beverages according to claim 1, wherein each processing unit comprises a transducer configured to convert each operating position of said at least one lever into a respective electrical signal.

7. Dispenser of beverages according to claim 1, wherein said transducer is selected from: a selecting member, a potentiometer, a magnetic sensor, an ultrasonic position sensor and an inductive sensor.

8. Dispenser of beverages according to claim 1, wherein said at least one regulating group comprises
a first selecting member coupled to said lever, and
a first switching device operable by said first selecting member,
wherein when said lever passes from said rest position to an operating position related to one of said operating positions, said first selecting member interferes with said first switching device so as to switch its state.

9. Dispenser of beverages according to claim 8, wherein said at least one control unit comprises
a second selecting member also coupled to said lever,
wherein said second selecting member is rotated by a predetermined angle with respect to said respective first selecting member, and
a second switching device operable by a respective second selecting member of a respective adjustment group,
so that when one of said levers rotates from said rest position to a further operating position related to one of said operating positions, said second selecting member interferes with said second switching device so as to switch its state.

10. Dispenser of beverages according to claim 8, wherein each switching device is operable by a respective selecting member.

11. Dispenser of beverages according to claim 1, wherein said lever is capable of rotating according to a first direction of rotation or a second direction of rotation, opposite to said first direction of rotation.

12. Dispenser of beverages according to claim 1, wherein each lever comprises at least one haptic device for providing haptic feedback, such as vibrations and the like, to a user when operating the respective lever for dispensing at least one of said beverages.

13. Dispenser of beverages according to claim 1, wherein said at least one haptic device is capable of providing different haptic feedback depending on said predefined flow rate and/or said type of beverage.
